(19) United States
(12) Patent Application Publication
(10) Pub. No.: US 2026/0183936 A1
(43) Pub. Date: Jul. 2, 2026

(54) PICKING DEVICE

(71) Applicant: Murata Machinery, Ltd., Kyoto-shi, Kyoto (JP)

(72) Inventors: Tetsuya Houki, Inuyama-shi, Aichi (JP); Yoshiyuki Azuma, Inuyama-shi, Aichi (JP); Seisuke Yokosuka, Inuyama-shi, Aichi (JP)

(73) Assignee: Murata Machinery, Ltd., Kyoto-shi, Kyoto (JP)

(21) Appl. No.: 18/865,833

(22) PCT Filed: May 16, 2023
(86) PCT No.: PCT/JP2023/018203

§ 371 Date: Nov. 14, 2024

(30) Foreign Application Priority Data
May 24, 2022 (JP) 2022-084385

(51) Int. Cl. B25J 9/00; B25J 5/04; B25J 15/06

(52) U.S. Cl. CPC B25J 9/0096; B25J 5/04; B25J 9/0084; B25J 15/0616

(57) ABSTRACT

A picking device that includes a first transfer device and a second transfer device that are guided by a rail and travel from a first area to a second area to transfer objects, and a transfer control device that controls the first transfer device and the second transfer device so that the first transfer device and the second transfer device pick up objects in parallel in the first area, travel in parallel along the rail, and then release the objects in parallel in the second area.

### CROSS REFERENCE TO RELATED APPLICATIONS

This application is a US national stage filing under 35 U.S.C. § 371 of International Application No. PCT/JP2023/018203, filed May 16, 2023, which claims priority to Japanese Patent Application No. 2022-084385, filed May 24, 2022, each of which is incorporated herein by reference in its entirety.

### TECHNICAL FIELD

This disclosure relates to a picking device that picks up and transports an object and releases the object in a predetermined place.

### BACKGROUND

In a distribution center or the like, a so-called picking operation in which a plurality of types of products corresponding to retail stores, individuals, and the like are sorted into cardboard boxes is an operation that has a great influence on efficiency in distribution. Although the picking operation has been conventionally performed by a human, the picking operation is recently attempted to be performed by a picking robot.

For example, Japanese Unexamined Patent Application Publication No. 2020-037144 discloses a picking device in which two picking robots are arranged side by side. Thus, efficiency of the picking operation performed by the picking robots is intended to be improved.

However, in the conventional technique disclosed in Japanese Unexamined Patent Application Publication No. 2020-037144, since operations of picking up, transporting, and releasing an object are individually controlled at mutually different timings for two picking robots, the two picking robots have to be controlled to not interfere with each other, and thus picking efficiency of a picking system as a whole is reduced.

It could therefore be helpful to provide a picking device including a plurality of transfer devices and to improve transportation efficiency of objects picked up.

### SUMMARY

Disclosed herein is a picking device including: a rail that extends over a first area and a second area; a first transfer device that transports an object from the first area to the second area by picking up the object in the first area, traveling along the rail, and then releasing the object in the second area, the first transfer device including a first traveling body that travels while being guided by the rail, a first arm that includes a proximal end portion attached to the first traveling body, and a first holding device that is attached to a distal end portion of the first arm to hold an object; a second transfer device that transports an object from the first area to the second area by picking up the object in the first area, traveling along the rail, and then releasing the object in the second area, the second transfer device including a second traveling body that travels while being guided by the rail, a second arm that includes a proximal end portion attached to the second traveling body, and a second holding device that is attached to a distal end portion of the second arm to hold an object; and a transfer control device that controls the first transfer device and the second transfer device to cause the first transfer device and the second transfer device to pick up objects in parallel in the first area, travel in parallel along the rail, and then release the objects in parallel in the second area.

Since the first transfer device and the second transfer device perform, in parallel, a series of operations of picking up objects in the first area, traveling along the rail, and releasing the objects in the second area, transportation efficiency of objects can be improved as compared to a conventional configuration in which each of operations, such as picking up and releasing an object, performed by a transfer device and each of operations, such as picking up and releasing an object, performed by another transfer device that operates in the vicinity of the transfer device are performed at mutually different timings between the transfer devices.

### BRIEF DESCRIPTION OF THE DRAWINGS

FIG. 1 is a perspective view illustrating a picking device.

FIG. 2 is a perspective view illustrating a first transfer device and a second transfer device.

FIG. 3 is a side view illustrating an aspect of a possible posture of the first transfer device based on a structure of the first transfer device.

FIG. 4 is a block diagram illustrating a functional configuration of a transfer control device.

FIG. 5 is a plan view illustrating a first example of an arrangement of a first holding device and a second holding device.

FIG. 6 is a plan view illustrating a second example of the arrangement of the first holding device and the second holding device.

FIG. 7 is a plan view illustrating a state in which a first object and a second object overlap each other and cannot be picked up in parallel.

FIG. 8 is a plan view illustrating a state in which a first object and a second object overlap each other and can be picked up in parallel.

FIG. 9 is a diagram for explaining terms in detection logic for the first transfer device to avoid collision with the second transfer device.

FIG. 10 is a perspective view illustrating another example of a transfer device.

### DETAILED DESCRIPTION

Hereinbelow, an example of a picking device is described with reference to the Drawings. It should be noted that the below is a mere example for explaining our device, and therefore is not intended to limit the scope of this disclosure. For example, the shape, structure, material, constituent element, relative positional relationship, connection state, numerical value, mathematical expression, content of each of steps of a method, processing order of the steps, etc. in the example below are mere examples and may include content not described below. Moreover, although geometric terms such as parallel, orthogonal, etc. may be used, these terms do not mean mathematical exactness and include a substantially allowable error or deviation. Moreover, terms such as simultaneously, same, etc. include a substantially allowable range.

Furthermore, the Drawings may include exaggerations, omissions, or scale adjustments for the purpose of explaining our device, and may be schematic drawings in which the shape, positional relationship, and scale are modified from the actual shape, positional relationship, and scale. Furthermore, the X-axis, Y-axis, and Z-axis in the Drawings indicate Cartesian coordinates arbitrarily set for explaining the Drawings. Namely, the Z-axis is not limited to an axis along a vertical direction, and the X-axis and Y-axis are not necessarily present in a horizontal plane.

Moreover, the following description may comprehensively explain a plurality of inventions as one example. Furthermore, part of the content described below is a description of an arbitrary constituent element related to this disclosure.

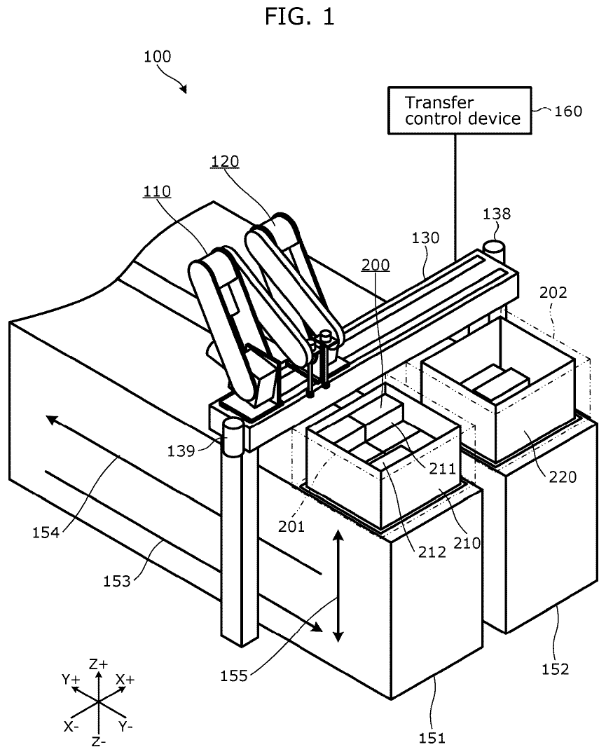

FIG. 1 is a perspective view illustrating picking device 100. Picking device 100 includes rail 130, first transfer device 110 that travels along rail 130 and transfers object 200 from first area 201 to second area 202, and second transfer device 120 that travels along rail 130 and transfers object 200 from first area 201 to second area 202. Picking device 100 includes first transport device 151 and second transport device 152.

First area 201 is an area in which object 200 to be transferred is placed and object 200 placed is picked up by picking device 100. Transfer source box 210 in which objects 200 to be picked up are contained is placed in first area 201. Objects 200 that are products of one type are contained in transfer source box 210, and objects 200 that are products of another type are contained in another transfer source box 210. It should be noted that there may be an instance where objects 200 that are products of the same type are contained in different transfer source boxes 210, or where objects 200 that are products of a plurality of types are contained in a single transfer source box 210. Second area 202 is an area to which object 200 is transferred and an area in which object 200 picked up in first area 201 is released. Transfer destination box 220 in which object 200 released is to be contained is placed in second area 202. One or more objects 200 of the same type are transferred from a single transfer source box 210 to transfer destination box 220. Moreover, there may be an instance where one or more objects 200 of the same type or different types are transferred from different transfer source boxes 210.

First transport device 151 transports, to first area 201, transfer source box 210 in which objects 200 are contained. Moreover, first transport device 151 transports transfer source box 210 out of first area 201 after at least one of objects 200 contained in transfer source box 210 has been transported out by at least one of first transfer device 110 or second transfer device 120. The type of first transport device 151 is not particularly limited and is exemplified by, for example, a conveyor, an unmanned transport vehicle, or the like. First transport device 151 includes forward conveyor 153 and backward conveyor 154 that are arranged in an up and down direction, and lifting and lowering device 155 that lifts, to first area 201, transfer source box 210 received from forward conveyor 153, lowers, to backward conveyor 154, transfer source box 210 from which the at least one of objects 200 has been transferred, and passes transfer source box 210 to backward conveyor 154.

Second transport device 152 transports, to second area 202, transfer destination box 220 in which the at least one of objects 200 is to be contained. Moreover, second transport device 152 transports transfer destination box 220 out of second area 202 after the at least one of objects 200 has been transported into transfer destination box 220 by at least one of first transfer device 110 or second transfer device 120. The type of second transport device 152 is not particularly limited and is exemplified by, for example, a conveyor, an unmanned transport vehicle, or the like. Second transport device 152 may have the same configuration as that of first transport device 151 or have a configuration different from that of first transport device 151, and may be of a type different from that of first transport device 151. Second transport device 152 is configured in the same manner as first transport device 151 and includes a forward conveyor (not illustrated), a backward conveyor (not illustrated), and a lifting and lowering device (not illustrated).

Rail 130 is a component that guides reciprocating movement of first transfer device 110 and second transfer device 120 over first area 201 and second area 202. Rail 130 is disposed on a side of first area 201 and second area 202 (a side to which first transport device 151 and second transport device 152 extend), and extends straight from first area 201 to second area 202. Rail 130 is disposed above first transport device 151 and second transport device 152 in a state in which rail 130 straddles at least one of first transport device 151 or second transport device 152 (straddles both of first transport device 151 and second transport device 152). It should be noted that when each of first transport device 151 and second transport device 152 is a cart, rail 130 may be disposed so that first transport device 151 and second transport device 152 can pass under rail 130

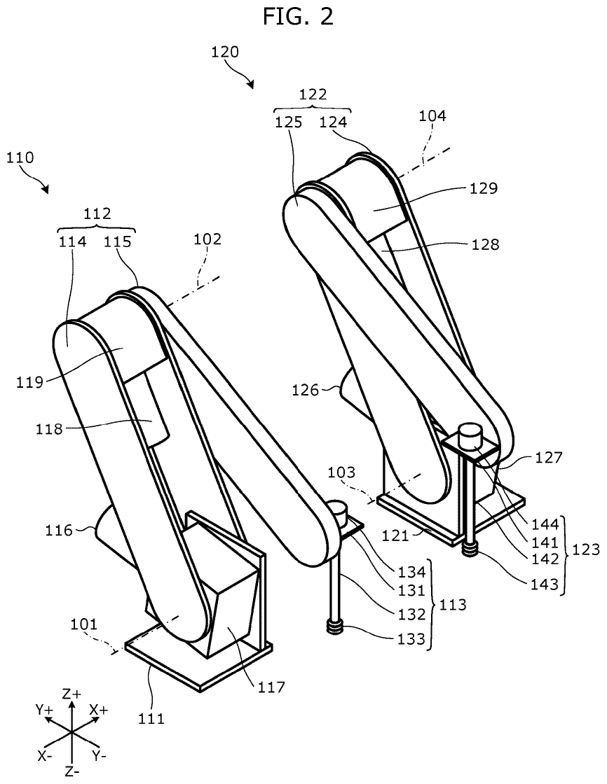

FIG. 2 is a perspective view illustrating first transfer device 110 and second transfer device 120. First transfer device 110 is a device that transfers object 200 from first area 201 to second area 202. The type of first transfer device 110 is not particularly limited and can be exemplified by an orthogonal robot, an articulated robot, a parallel link robot, or the like. A perpendicular articulated robot is employed as first transfer device 110. First transfer device 110 includes first traveling body 111, first arm 112, and first holding device 113.

First traveling body 111 is a basic component of first transfer device 110, and is a component that reciprocates in the extending direction of rail 130 (the X-axis direction in the Drawings) while being guided by rail 130. A driving method for causing first traveling body 111 to travel along rail 130 is not particularly limited. First traveling body 111 is linked to a ring-shaped belt (not illustrated) disposed inside rail 130. The ring-shaped belt is rotated by first travel driving source 138 (see FIG. 1) including a motor attached to rail 130 so that first traveling body 111 reciprocates in the extending direction of rail 130 while being guided by rail 130. It should be noted that first traveling body 111 may be driven by a linear motor or may travel based on rotation of a ball screw, a feed screw, or the like.

First arm 112 is a component that includes a distal end portion and a proximal end portion that is attached to first traveling body 111, and moves first holding device 113 attached to the distal end portion to an arbitrary position in first area 201 and an arbitrary position in second area 202. First arm 112 includes: first upper arm 114 that is attached to first traveling body 111 so that first upper arm 114 can rotate about first rotation axis 101 extending along the extending direction of rail 130 (the X-axis direction in the Drawings); and first forearm 115 that is attached to a side (side facing second transfer device 120) of a distal end portion of first upper arm 114 so that first forearm 115 can rotate about second rotation axis 102 that is parallel to first rotation axis 101. αααα

First upper arm 114 is attached to first traveling body 111 at its proximal end portion so that first upper arm 114 can rotate with respect to first traveling body 111 in a first plane (the YZ plane in the Drawings) that is a prescribed plane intersecting (orthogonal to) the extending direction of rail 130 and cannot move relative to the extending direction. First upper arm 114 is linked to first upper arm driver 117 including first upper arm motor 116, and is driven with respect to first traveling body 111 by a driving force from first upper arm driver 117. Specifically, first upper arm 114 is rotated about first rotation axis 101 with respect to first traveling body 111. First forearm 115 is attached to the distal end portion of first upper arm 114 at its proximal end portion so that first forearm 115 can rotate with respect to first upper arm 114 in a plane parallel to the first plane and cannot move relative to the extending direction. First forearm 115 is linked to first forearm driver 119 including first forearm motor 118, and is driven with respect to first upper arm 114 by a driving force from first forearm driver 119. Specifically, first forearm 115 is rotated about second rotation axis 102 with respect to first upper arm 114.

According to such a configuration, each of first upper arm 114 and first forearm 115 included in first arm 112 moves in a plane parallel to the first plane but does not move in the extending direction of rail 130 in a state in which the position of first traveling body 111 is fixed. Moreover, first holding device 113 attached to first arm 112 also moves in a plane parallel to the first plane but does not move in the extending direction of rail 130 in a state in which the position of first traveling body 111 is fixed.

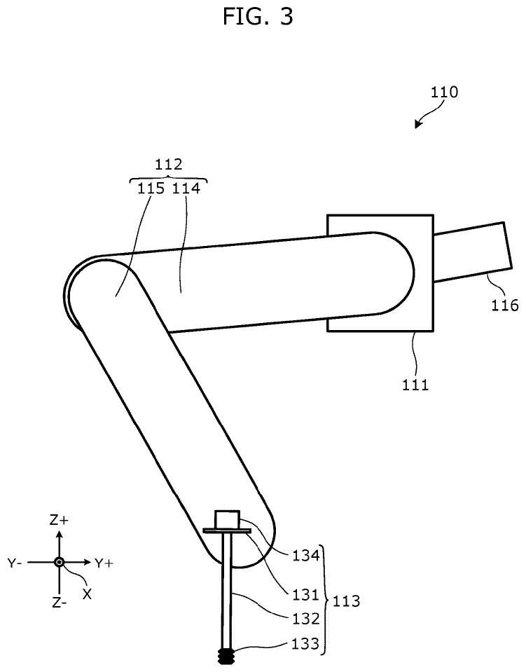

First forearm 115 is attached to a second transfer device 120-side lateral face of first upper arm 114. First holding device 113 is attached to a second transfer device 120-side lateral face of a distal end portion of first forearm 115 so that first holding device 113 protrudes toward second transfer device 120. In other words, first holding device 113 is attached on a side opposite to first upper arm 114 with respect to first forearm 115. Namely, first upper arm 114, first forearm 115, and first holding device 113 are arranged at positions mutually displaced (offset) with respect to the extending direction of rail 130. Thus, even when first forearm 115 rotates with respect to first upper arm 114, first holding device 113 does not interfere with first upper arm 114. Accordingly, a range in which first holding device 113 is placed (is movable) can be expanded. For example, as illustrated in FIG. 3, when first transfer device 110 is viewed in the extending direction of rail 130 (the X-axis direction), a posture in which first forearm 115 is located directly below first upper arm 114 and first holding device 113 is located in the vicinity of first traveling body 111 with respect to the Y-axis direction (first holding device 113 approaches a position close to a place directly below first traveling body 111) becomes possible.

First holding device 113 is a device that is attached to first arm 112 and disposed at a desired position in first area 201 and second area 202, and can hold object 200 and release object 200 held. First holding device 113 is attached to the distal end portion of first forearm 115. First holding device 113 includes first hand 131, first rod 132, first holder 133, and first rotator 134.

First hand 131 is a plate-like component that is attached to first forearm 115 so that first hand 131 is kept in a fixed angle with respect to first traveling body 111 by a first link mechanism (not illustrated).

First rod 132 is a bar-like component that is attached to first hand 131 to protrude in a direction perpendicular to first hand 131. When first holding device 113 holds object 200 by suction, first rod 132 may be in a tubular shape serving as a suction passage.

First holder 133 is a component that is attached to a distal end portion (lower end portion) of first rod 132 to hold object 200. The type of first holder 133 is not particularly limited and, first holder 133 may be, for example, a chuck that sandwiches and holds object 200. In the present embodiment, first holding device 113 is a device that holds object 200 by vacuum suction, and first holder 133 is a suction pad.

First rotator 134 is a device that causes first rod 132 to rotate about an axial center with respect to first hand 131, and includes a motor. When first holder 133 is a chuck or the like, first rotator 134 may cause the chuck to rotate according to the posture of object 200. In the present embodiment, first rotator 134 changes, by rotation, the posture of object 200 held and sucked at a distal end of first holder 133 so that object 200 can be released in a desired posture in second area 202.

Similar to first transfer device 110, second transfer device 120 is a device that transfers object 200 from first area 201 to second area 202. The type of second transfer device 120 is not particularly limited and is exemplified by an orthogonal robot, an articulated robot, a parallel link robot, or the like. Second transfer device 120 is of the same type as that of first transfer device 110, and a perpendicular articulated robot is employed as second transfer device 120. Second transfer device 120 includes second traveling body 121, second arm 122, and second holding device 123.

Second traveling body 121 is a basic component of second transfer device 120, and is a component that reciprocates in the extending direction of rail 130 (the X-axis direction in the Drawings) while being guided by rail 130. A driving method for causing second traveling body 121 to travel along rail 130 is not particularly limited. In the present embodiment, second traveling body 121 is linked to a ring-shaped belt (not illustrated) disposed inside rail 130. The belt linked to second traveling body 121 is separate from the belt linked to first traveling body 111, and the belt linked to second traveling body 121 and the belt linked to first traveling body 111 rotate independently of the other. The ring-shaped belt is rotated by second travel driving source 139 (see FIG. 1) including a motor attached to rail 130 so that second traveling body 121 reciprocates in the extending direction of rail 130 while being guided by rail 130. It should be noted that second traveling body 121 may be driven by a linear motor or may travel based on rotation of a ball screw, a feed screw, or the like.

Second arm 122 is a component that includes a distal end portion and a proximal end portion that is attached to second traveling body 121, and moves second holding device 123 attached to the distal end portion to an arbitrary position in first area 201 and an arbitrary position in second area 202. In the present embodiment, second arm 122 includes: second upper arm 124 that is attached to second traveling body 121 so that second upper arm 124 can rotate about third rotation axis 103 extending along the extending direction of rail 130 (the X-axis direction in the Drawings); and second forearm 125 that is attached to a side (side facing first transfer device 110) of a distal end portion of second upper arm 124 so that second forearm 125 can rotate about fourth rotation axis 104 that is parallel to third rotation axis 103.

Second upper arm 124 is attached to second traveling body 121 at its proximal end portion so that second upper arm 124 can rotate with respect to second traveling body 121 in a plane parallel to the first plane and cannot move relative to the extending direction. Second upper arm 124 is linked to second upper arm driver 127 including second upper arm motor 126, and is driven with respect to second traveling body 121 by a driving force from second upper arm driver 127. Specifically, second upper arm 124 is rotated about third rotation axis 103 with respect to second traveling body 121. Second forearm 125 is attached to the distal end portion of second upper arm 124 at its proximal end portion so that second forearm 125 can rotate with respect to second upper arm 124 in a plane parallel to the first plane and cannot move relative to the extending direction. Second forearm 125 is linked to second forearm driver 129 including second forearm motor 128, and is rotated and driven with respect to second upper arm 124 by a driving force from second forearm driver 129. Specifically, second forearm 125 is rotated about fourth rotation axis 104 with respect to second upper arm 124.

According to such a configuration, each of second upper arm 124 and second forearm 125 included in second arm 122 moves in a plane parallel to the first plane. However, each of second upper arm 124 and second forearm 125 does not move in the extending direction of rail 130 in a state in which the position of second traveling body 121 is fixed. Moreover, second holding device 123 attached to second arm 122 also moves in a plane parallel to the first plane but does not move in the extending direction of rail 130 in a state in which the position of second traveling body 121 is fixed. It should be noted that the first plane is a virtual plane and the location of the first plane is not particularly limited. Moreover, the first plane and a second plane may be the same plane.

Second forearm 125 is attached to a first transfer device 110-side lateral face of second upper arm 124. Second holding device 123 is attached to a first transfer device 110-side lateral face of a distal end portion of second forearm 125 so that second holding device 123 protrudes toward first transfer device 110. In other words, second holding device 123 is attached to a side opposite to second upper arm 124 with respect to second forearm 125. Namely, second upper arm 124, second forearm 125, and second holding device 123 are arranged at positions mutually displaced (offset) with respect to the extending direction of rail 130. Thus, even when second forearm 125 rotates with respect to second upper arm 124, second holding device 123 does not interfere with second upper arm 124. Accordingly, a range in which second holding device 123 is placed (is movable) can be expanded. For example, similar to first transfer device 110 illustrated in FIG. 3, when second transfer device 120 is viewed in the extending direction of rail 130 (the X-axis direction), a posture in which second forearm 125 is located directly below second upper arm 124 and second holding device 123 is located in the vicinity of second traveling body 121 with respect to the Y-axis direction (second holding device 123 approaches a position close to a place directly below second traveling body 121) becomes possible.

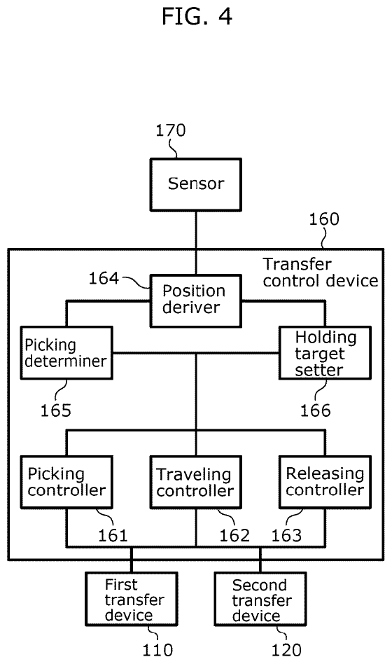

First transfer device 110 and second transfer device 120 have a plane-symmetrical structure with respect to the YZ plane in the Drawings. Accordingly, as illustrated in FIG. 4 described below, first transfer device 110 and second transfer device 120 can be arranged as close as possible to each other while avoiding interference between first holding device 113 and second holding device 123.

Second holding device 123 is a device that is attached to second arm 122 and placed at a desired position in first area 201 and second area 202, and can hold object 200 and release object 200 held. Second holding device 123 is attached to the distal end portion of second forearm 125. In the present embodiment, second holding device 123 includes second hand 141, second rod 142, second holder 143, and second rotator 144.

Second hand 141 is a plate-like component that is attached to second forearm 125 so that second hand 141 is kept in a fixed angle with respect to second traveling body 121 by a second link mechanism (not illustrated).

Second rod 142 is a bar-like component that is attached to second hand 141 to protrude in a direction perpendicular to second hand 141. When second holding device 123 holds object 200 by suction, second rod 142 may be in a tubular shape serving as a suction passage.

Second holder 143 is a component that is attached to a distal end portion of second rod 142 to hold object 200. The type of second holder 143 is not particularly limited and, second holder 143 may be, for example, a chuck that sandwiches and holds object 200. Second holding device 123 is a device that holds object 200 by vacuum suction, and second holder 143 is a suction pad.

Second rotator 144 is a device that causes second rod 142 to rotate about an axial center with respect to second hand 141, and includes a motor. When second holder 143 is a chuck or the like, second rotator 144 may cause the chuck to rotate according to the posture of object 200. Second rotator 144 changes, by rotation, the posture of object 200 held and sucked at a distal end of second holder 143 so that object 200 can be released in a desired posture in second area 202.

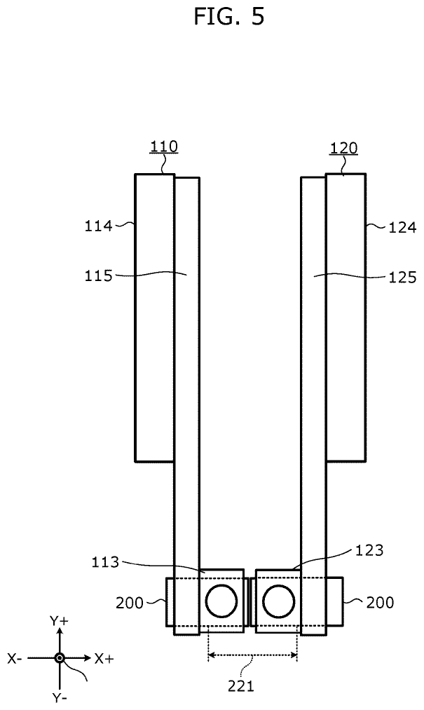

FIG. 5 is a plan view for explaining a possible relative positional relationship between first holding device 113 included in first transfer device 110 and second holding device 123 included in second transfer device 120. As illustrated in FIG. 4, in the plan view, first holding device 113 (first holder 133) included in first transfer device 110 is provided to protrude toward second transfer device 120 with respect to first forearm 115. In the plan view, second holding device 123 (second holder 143) included in second transfer device 120 is provided to protrude toward first transfer device 110 with respect to second forearm 125.

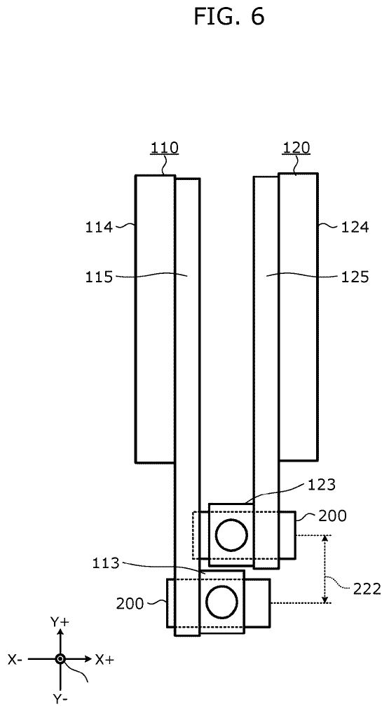

In picking device 100 configured as above, as illustrated in FIG. 6, since first holding device 113 and second holding device 123 are arranged at positions mutually displaced (positions not overlapping each other) with respect to a direction (the Y-axis direction in FIG. 6) that is horizontal and perpendicular to the extending direction of rail 130, first holding device 113 and second holding device 123 can be at least partially located at the same position (positions overlapping each other) with respect to the extending direction of rail 130 (the X-axis direction in FIG. 6). With such a configuration, as illustrated in FIG. 6, first holding device 113 and second holding device 123 can simultaneously (at the same time) pick up two objects 200 that are at least partially located at the same position with respect to the X-axis direction.

In contrast, such a relative positional relationship cannot be achieved by a configuration in which first holding device 113 is provided to not protrude toward second transfer device 120 with respect to first forearm 115 (first holding device 113 is provided at the same position as first forearm 115 with respect to the X-axis direction or provided to protrude toward first transfer device 110) and a configuration in which second holding device 123 is provided to not protrude toward first transfer device 110 with respect to second forearm 125 (second holding device 123 is provided at the same position as second forearm 125 with respect to the X-axis direction or provided to protrude toward second transfer device 120). Therefore, first holding device 113 and second holding device 123 cannot simultaneously (at the same time) pick up two objects 200 that are at least partially located at the same position with respect to the X-axis direction.

With picking device 100, since first transfer device 110 and second transfer device 120 travel while being guided by the same rail 130 to transfer objects 200 from first area 201 to second area 202, objects 200 can be transferred by a distance that is greater than or equal to a distance that can be reached by an arm included in each of first transfer device 110 and second transfer device 120 when the arm is stretched out. Moreover, since first transfer device 110 and second transfer device 120 cooperate to transfer objects 200, transfer efficiency can be improved as compared to a configuration in which a single transfer device transfers object 200.

Furthermore, since rail 130 is disposed to straddle first transport device 151 and second transport device 152, and first transfer device 110 and second transfer device 120 move in a state in which first transfer device 110 and second transfer device 120 three-dimensionally cross first transport device 151 and second transport device 152, picking device 100 can be made compact as a whole.

Furthermore, since first arm 112 and second arm 122 are configured to cause each of first holding device 113 and second holding device 123 to move in a plane perpendicular to the extending direction of rail 130 and not to move along the extending direction of rail 130, only a distance between first traveling body 111 and second traveling body 121 in the extending direction of rail 130 needs to be monitored for interference prevention control of first transfer device 110 and second transfer device 120, and picking device 100 is easy to control as compared to a picking device including two transfer devices of which arms interfere with each other.

Furthermore, first holding device 113 and second holding device 123 protruding in a mutually approaching direction can be arranged side by side in a direction (the Y-axis direction in the Drawings) orthogonal to the extending direction of rail 130 (the X-axis direction in the Drawings) as illustrated in FIG. 6, and first transfer device 110 and second transfer device 120 can simultaneously pick up two objects 200 that are adjacent to each other in the extending direction of rail 130 or two objects 200 that are displaced from each other in the direction (the Y-axis direction) orthogonal to the extending direction of rail 130 and overlapping each other in the extending direction of rail 130 (the X-axis direction). Furthermore, first transfer device 110 and second transfer device 120 can simultaneously release two objects 200 in a state in which two objects 200 are adjacent to each other.

Furthermore, since first upper arm 114 and first holding device 113 are arranged to not interfere with each other and first forearm 115 can be rotated freely regardless of the posture of first upper arm 114, first holding device 113 can also be located directly below first upper arm 114 in a side view. Accordingly, object 200 can be picked up or released also at a position close to and below first transfer device 110. This effect is the same for second transfer device 120.

FIG. 4 is a block diagram illustrating a functional configuration of transfer control device 160. Transfer control device 160 is a device including a processor that controls operation of first transfer device 110 and operation of second transfer device 120.

Transfer control device 160 controls first transfer device 110 and second transfer device 120 so that first transfer device 110 and second transfer device 120 pick up objects 200 in parallel in first area 201, travel in parallel along rail 130, and then release objects 200 in parallel in second area 202. In other words, transfer control device 160 controls first transfer device 110 and second transfer device 120 so that an operation in which first transfer device 110 picks up object 200 in first area 201 and an operation in which second transfer device 120 picks up object 200 in first area 201 are at least temporarily performed in parallel (preferably, are simultaneously performed). Subsequently, transfer control device 160 controls first transfer device 110 and second transfer device 120 so that an operation in which first transfer device 110 holding object 200 travels along rail 130 toward second area 202 and an operation in which second transfer device 120 holding object 200 travels along rail 130 toward second area 202 are at least temporarily performed in parallel (preferably, are simultaneously performed). Subsequently, transfer control device 160 controls first transfer device 110 and second transfer device 120 so that an operation in which object 200 held by first transfer device 110 is released in second area 202 and an operation in which object 200 held by second transfer device 120 is released in second area 202 are at least temporarily performed in parallel (preferably, are simultaneously performed).

In an aspect in which first transfer device 110 and second transfer device 120 are individually controlled regarding operations of picking up object 200 in first area 201, traveling along rail 130, and then releasing object 200 in second area 202, there is a possibility that, for example, first transfer device 110 has to wait until second transfer device 120 completes picking up object 200 in first area 201 and cannot start traveling toward second area 202 even when first transfer device 110 has completed picking up object 200 in first area 201. In contrast, in picking device 100, according to the above-described control, since first transfer device 110 and second transfer device 120 perform, in parallel, a series of operations of picking up objects 200 in first area 201, traveling along rail 130, and then releasing objects 200 in second area 202 as if first transfer device 110 and second transfer device 120 operated in synchronization, picking device 100 can improve transportation efficiency of objects as compared to a conventional configuration in which each of operations, such as picking up and releasing an object, performed by a transfer device and each of operations, such as picking up and releasing an object, performed by another transfer device that operates in the vicinity of the transfer device are performed at mutually different timings between the transfer devices.

For achieving the above-described control, transfer control device 160 includes, as processing units realized by a processor executing a program, picking controller 161, traveling controller 162, and releasing controller 163. In the present embodiment, transfer control device 160 includes position deriver 164, picking determiner 165, and holding target setter 166.

Position deriver 164 derives the positions of first object 211 and second object 212 placed in first area 201. Position deriver 164 derives the positions of objects 200 placed in first area 201 as many as possible. Position deriver 164 derives the positions of objects 200 based on information from sensor 170. Although the type of sensor 170 is not particularly limited, sensor 170 can be exemplified by a 3D sensor that emits lattice-shaped or stripe-shaped light from above to objects 200 in first area 201 and obtains an image in which the light on objects 200 has been captured by an image capturing device. Position deriver 164 derives the shape of each of objects 200, the position in a horizontal plane of each of objects 200, the height position of an upper face of each of objects 200, and the like, based on distortion of the tip of the light in the image.

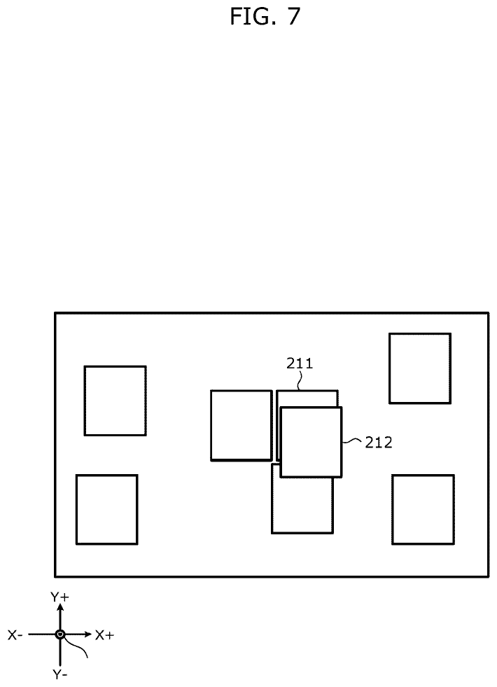

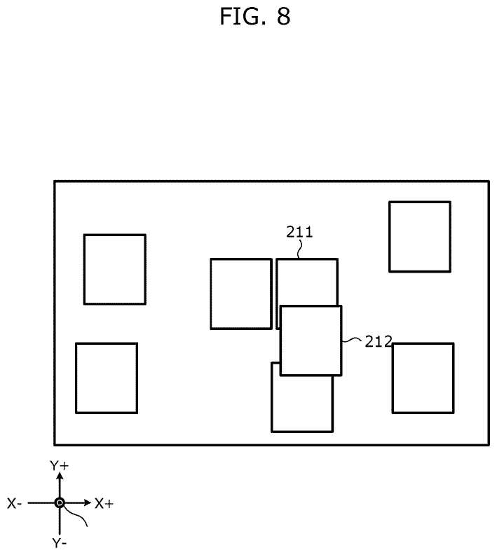

Picking determiner 165 determines whether first object 211 and second object 212 can be picked up in parallel, based on the positions of first object 211 and second object 212 obtained by position deriver 164. A determination method used by picking determiner 165 is not particularly limited. For example, picking determiner 165 determines that first object 211 and second object 212 can be picked up in parallel when a distance between first object 211 and second object 212 is greater than or equal to first distance 221 that is a distance that enables first holding device 113 and second holding device 123 to hold first object 211 and second object 212 in parallel in a state in which first holding device 113 and second holding device 123 are arranged side by side in the extending direction of rail 130 (the X-axis direction in the Drawings) and are closest to each other, as illustrated in FIG. 5, and picking determiner 165 determines that first object 211 and second object 212 cannot be picked up in parallel when the distance between first object 211 and second object 212 is less than first distance 221. Moreover, picking determiner 165 may determine that first object 211 and second object 212 can be picked up in parallel when the distance between first object 211 and second object 212 is greater than or equal to second distance 222 that is a distance that enables first holding device 113 and second holding device 123 to hold first object 211 and second object 212 in parallel in a state in which first holding device 113 and second holding device 123 are arranged side by side in a direction (the Y-axis direction in the Drawings) orthogonal to the extending direction of rail 130 in a horizontal plane and are closest to each other, as illustrated in FIG. 6, and picking determiner 165 may determine that first object 211 and second object 212 cannot be picked up in parallel when the distance between first object 211 and second object 212 is less than second distance 222. Furthermore, picking determiner 165 may determine that first object 211 and second object 212 cannot be picked up in parallel when first object 211 and second object 212 overlap each other in a vertical direction (the Z-axis direction in the Drawings), as illustrated in FIG. 7. Furthermore, even when first object 211 and second object 212 overlap each other in the vertical direction (the Z-axis direction in the Drawings), picking determiner 165 may determine that first object 211 and second object 212 can be picked up in parallel if the center of gravity of object 200 located lower, among first object 211 and second object 212, is not hidden by object 200 located upper, among first object 211 and second object 212, as illustrated in FIG. 8.

Holding target setter 166 determines the order of picking up objects 200 placed in first area 201 and sets first object 211 and second object 212. Specifically, holding target setter 166 uses the initial value of variable N (N is an integer greater than or equal to two) set to 2, extracts a first height object at the highest height position among height positions determined by position deriver 164 and an N-th height object at the N-th highest height position among the height positions, increases N in increments of one until picking determiner 165 determines that the first height object and the N-th height object can be picked up in parallel, and sets, as first object 211 and second object 212, the first height object and the N-th height object that have been determined as objects that can be picked up in parallel.

In other words, holding target setter 166 first extracts a first height object at the highest height position among height positions determined by position deriver 164 and a second height object at the second (N=2) highest height position among the height positions, and then picking determiner 165 determines whether the first height object and the second height object can be picked up in parallel. When a result of the determination is positive, the first height object at the highest height position is set as first object 211 and the second height object at the second highest position is set as second object 212; however, when the result of the determination is negative, holding target setter 166 extracts the first height object at the highest height position among the height positions determined by position deriver 164 and a third height object at the third (N=3) highest position among the height positions, and picking determiner 165 determines whether the first height object and the third height object can be picked up in parallel. Hereinafter, holding target setter 166 increases N in increments of one until picking determiner 165 determines that the first height object and the N-th height object can be picked up in parallel, and sets the first height object and the N-th object as first object 211 and second object 212.

Picking controller 161 controls a picking operation of each of first transfer device 110 and second transfer device 120 so that first transfer device 110 and second transfer device 120 pick up, in parallel, first object 211 and second object 212 in first area 201 that have been determined, by picking determiner 165, as objects that can be picked up in parallel. Picking up in parallel means that first transfer device 110 and second transfer device 120 perform, at the same time, at least part of a series of holding operations of operating an arm to cause a holder not holding object 200 to move to a position for holding object 200 and cause the holder to hold object 200 and operating the arm to move object 200 held to a predetermined place. Picking controller 161 controls first transfer device 110 and second transfer device 120 so that first transfer device 110 and second transfer device 120 execute the series of holding operations in a state in which first transfer device 110 and second transfer device 120 are almost synchronized with each other with a time difference of approximately one to several times of a control cycle. Specifically, picking controller 161 controls operation of first upper arm driver 117, operation of first forearm driver 119, operation of second upper arm driver 127, and operation of second forearm driver 129 in parallel to pick up first object 211 and second object 212 in parallel.

When picking determiner 165 determines that first object 211 and second object 212 cannot be picked up in parallel, picking controller 161 controls first transfer device 110 and second transfer device 120 so that picking up first object 211 and picking up second object 212 are sequentially performed. In the present embodiment, when picking determiner 165 determines that first object 211 and second object 212 cannot be picked up in parallel is when picking determiner 165 determines that a first height object and an N-th height object cannot be picked up in parallel after picking determiner 165 has performed the above-described determination repeatedly until variable N becomes a maximum value.

First object 211 and second object 212 are objects 200 that have been selected as targets of a holding operation from among objects 200 placed in first area 201. It should be noted that first transfer device 110 can pick up either first object 211 or second object 212 and second transfer device 120 can pick up either first object 211 or second object 212.

Transfer control device 160 controls operation of first transfer device 110 and second transfer device 120 so that first holding device 113 and second holding device 123 do not interfere (contact) with each other. Specifically, transfer control device 160 controls driving of first transfer device 110 and second transfer device 120 so that a position obtained by adding, on a second transfer device 120-side in the extending direction, a prescribed buffer distance to a first normal stop position at which first holding device 113 can stop when first transfer device 110 continues decelerating at a maximum deceleration is not located on the second transfer device 120-side in the extending direction with respect to a second normal stop position at which second holding device 123 can stop when second transfer device 120 continues decelerating at a maximum deceleration.

When a relative distance, in the extending direction, between two objects 200 to be picked up by first transfer device 110 and second transfer device 120 is determined to be greater than or equal to a prescribed threshold, transfer control device 160 controls driving of first transfer device 110 and second transfer device 120 by using a first distance as the buffer distance, and when the relative distance, in the extending direction, between two objects 200 is determined to be less than the prescribed threshold, transfer control device 160 controls driving of first transfer device 110 and second transfer device 120 by using, as the buffer distance, a second distance that is shorter than the first distance.

Traveling controller 162 controls first travel driving source 138 of first transfer device 110 and second travel driving source 139 of second transfer device 120 individually, and controls traveling of first transfer device 110 and second transfer device 120 along rail 130. Traveling controller 162 can also cause first transfer device 110 and second transfer device 120 to travel in parallel. Traveling in parallel means that a traveling operation of first transfer device 110 and a traveling operation of second transfer device 120 in the same direction are at least partially performed at the same time.

Traveling controller 162 controls first transfer device 110 and second transfer device 120 in either a normal mode or a proximate mode.

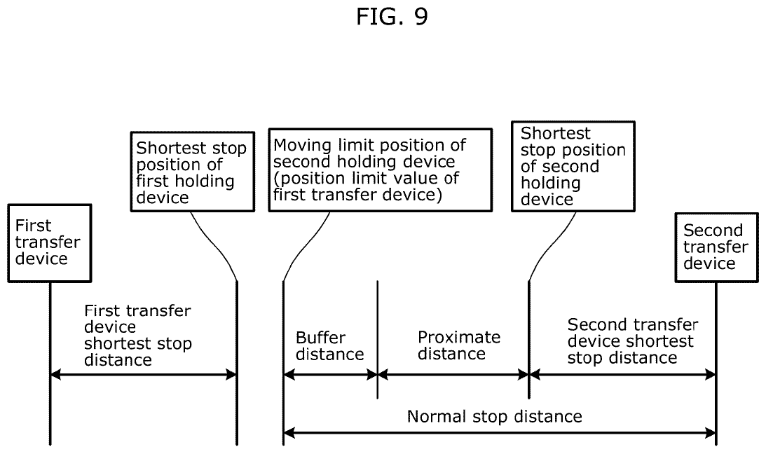

FIG. 9 is a diagram for explaining terms in detection logic for first transfer device 110 to avoid collision with second transfer device 120. A first transfer device shortest stop distance illustrated in FIG. 9 is a distance from a current position of first transfer device 110 (first holding device 113) to a position at which first holding device 113 stops when first transfer device 110 continues decelerating at the maximum deceleration and stops at a shortest stop distance. A second transfer device shortest stop distance is a distance from a current position of second transfer device 120 (second holding device 123) to a position at which second holding device 123 stops when second transfer device 120 continues decelerating at the maximum deceleration and stops at a shortest stop distance.

The normal mode is a mode for controlling traveling of first transfer device 110 and second transfer device 120 to cause first transfer device 110 and second transfer device 120 that have stopped in the vicinity of first area 201 for picking up objects 200 to stop at a normal stop distance to not overlap each other in the extending direction of rail 130 when the relative distance, in the extending direction, between two objects 200 to be picked up by first transfer device 110 and second transfer device 120 is greater than or equal to a prescribed threshold. The normal stop distance may be set based on a proximate distance that is a minimum distance required between first holding device 113 and second holding device 123 when first holding device 113 and second holding device 123 are arranged side by side in the extending direction of rail 130 as illustrated in FIG. 5, for example. Specifically, as illustrated in FIG. 9, the normal stop distance is set so that a moving limit position of second holding device 123 obtained by adding, to the second transfer device shortest stop distance, a proximate distance and a buffer distance that are margins for avoiding collision between first holding device 113 and second holding device 123 is located on the second transfer device 120-side (is not located on a first transfer device 110-side) with respect to a shortest stop position of first holding device 113 corresponding to the first transfer device shortest stop distance.

The proximate mode is a mode for causing first transfer device 110 and second transfer device 120 to stop at a distance shorter than the normal stop distance when the relative distance, in the extending direction, between two objects 200 to be picked up by first transfer device 110 and second transfer device 120 is less than the threshold. For example, the normal mode is transitioned to the proximate mode when a distance, in the extending direction of rail 130, between the position of first object 211 to be picked up and the position of second object 212 to be picked up obtained from position deriver 164 does not enable first transfer device 110 and second transfer device 120 stopped at the normal stop distance to pick up first object 211 and second object 212. For example, traveling controller 162 in the proximate mode controls traveling of at least one of first transfer device 110 or second transfer device 120 stopped at the normal stop distance so that the at least one of first transfer device 110 or second transfer device 120 stops at a proximate stop distance at which first holding device 113 and second holding device 123 overlap each other in a direction (the Y-axis direction in the Drawings) orthogonal to the extending direction of rail 130, as illustrated in FIG. 6. In this case, traveling controller 162 can cause the at least one of first transfer device 110 or second transfer device 120 to travel at a speed lower than that in the normal mode.

In the proximate mode, traveling controller 162 changes at least one of the proximate distance or the buffer distance to a value lower than that in the normal mode. For example, at least one of the proximate distance or the buffer distance is set to 0. When traveling controller 162 controls at least one of first transfer device 110 or second transfer device 120 so that the at least one of first transfer device 110 or second transfer device 120 stops at the proximate stop distance at which first holding device 113 and second holding device 123 overlap each other in the direction (the Y-axis direction in the Drawings) orthogonal to the extending direction of rail 130 as illustrated in FIG. 6, the proximate distance and the buffer distance may be set to negative values. Thus, since the proximate distance and the buffer distance are different between the normal mode and the proximate mode, collision between first holding device 113 and second holding device 123 can be surely avoided in the normal mode and a relative positional relationship as illustrated in FIG. 6, for example, can be achieved by causing first holding device 113 and second holding device 123 to be adjacent to each other in the proximate mode.

Releasing controller 163 controls a releasing operation of first transfer device 110 and a releasing operation of second transfer device 120 so that first object 211 and second object 212 picked up in first area 201 are released in parallel in second area 202. Releasing in parallel means that first transfer device 110 and second transfer device 120 perform, at the same time, at least part of a series of releasing operations of operating an arm to cause a holder holding object 200 to move to a position at which object 200 is released, releasing object 200, and operating the arm to move the holder not holding object 200 to a predetermined place. Releasing controller 163 controls first transfer device 110 and second transfer device 120 so that first transfer device 110 and second transfer device 120 execute the series of releasing operations in a state in which first transfer device 110 and second transfer device 120 are almost synchronized with each other with a time difference of approximately one to several times of a control cycle. Specifically, releasing controller 163 controls operation of first upper arm driver 117, operation of first forearm driver 119, operation of second upper arm driver 127, and operation of second forearm driver 129 in parallel to release first object 211 and second object 212 in parallel.

With picking device 100, since operation of first transfer device 110 and operation of second transfer device 120 are controlled in parallel, transportation efficiency of objects 200 can be improved as compared to a configuration in which picking up and releasing an object performed by a transfer device and picking up and releasing an object performed by another transfer device that operates in the vicinity of the transfer device are performed at different timings between the transfer devices.

Since first arm 112 and second arm 122 are configured to cause each of first holding device 113 and second holding device 123 to move in a plane perpendicular to the extending direction of rail 130 but not to move in the extending direction, traveling controller 162 only needs to control the motion of first traveling body 111 and second traveling body 121 in the extending direction of rail 130 for interference prevention control of first transfer device 110 and second transfer device 120, and picking device 100 is easy to control as compared to a picking system including a plurality of transfer devices each of which having a flexible arm or the like.

Moreover, in the normal mode, it is possible to cause first transfer device 110 and second transfer device 120 to travel at a high speed to improve efficiency of an operation of picking up two objects 200 that are distant from each other by a distance greater than or equal to a distance corresponding to the normal stop distance. When a plurality of objects 200 placed at positions adjacent to each other, positions overlapping each other in the extending direction of rail 130, or positions overlapping each other in an up and down direction are picked up, first object 211 and second object 212 can be picked up at almost the same time by switching to the proximate mode.

Moreover, since rail 130 is disposed to straddle first transport device 151 and second transport device 152 and first transfer device 110 and second transfer device 120 move in a state in which first transfer device 110 and second transfer device 120 three-dimensionally cross first transport device 151 and second transport device 152, picking device 100 can be made compact as a whole.

Furthermore, first holding device 113 and second holding device 123 protruding in a mutually approaching direction can be arranged side by side in a direction (the Y-axis direction in the Drawings) orthogonal to the extending direction of rail 130 (the X-axis direction in the Drawings) as illustrated in FIG. 6, and first transfer device 110 and second transfer device 120 can simultaneously pick up two objects 200 that are adjacent to each other in the extending direction of rail 130, displaced from each other in the direction orthogonal to the extending direction of rail 130, and overlapping each other in the extending direction of rail 130. Furthermore, two objects 200 can be simultaneously released in a state in which two objects 200 are adjacent to each other.

Furthermore, since first upper arm 114 and first holding device 113 are arranged to not interfere with each other and first forearm 115 can be rotated freely regardless of the posture of first upper arm 114, first holding device 113 can also be located directly below first upper arm 114. Accordingly, object 200 can be picked up or released also at a position close to and below first transfer device 110. This effect is the same for second transfer device 120.

It should be noted that this disclosure is not limited to the above-described example. For example, constituent elements recited in this disclosure may be arbitrarily combined, and/or one or more of the constituent elements may be omitted to produce another example. Moreover, various modifications of the above-described example that may be conceived by those skilled in the art are intended to be included within the spirit and scope of this disclosure, as long as they do not depart from the essence of this disclosure, that is, the meaning represented by the wording in the claims.

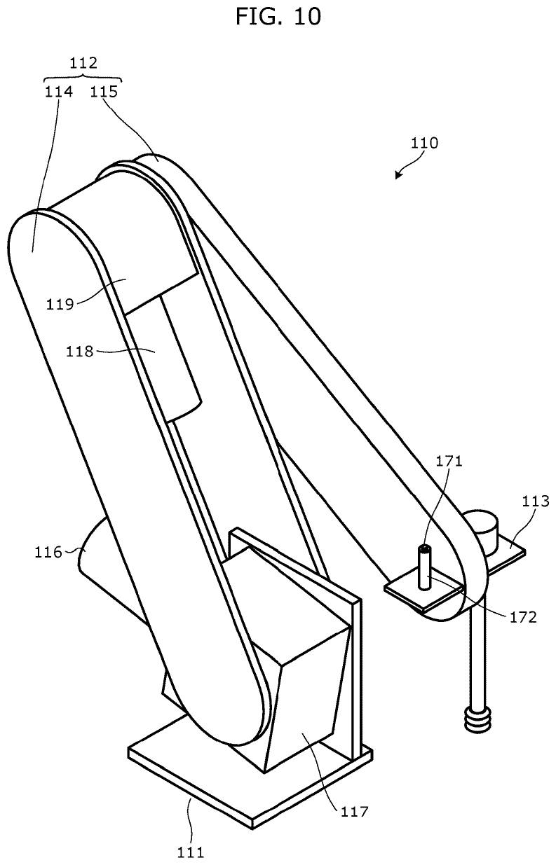

For example, as illustrated in FIG. 10, first transfer device 110 may include holding lever 172 including brake releasing switch 171 at its distal end. An operator can arbitrarily rotate first upper arm 114 and first forearm 115 to place first holding device 113 at an arbitrary position by pressing brake releasing switch 171 to release electromagnetic brakes included in first upper arm motor 116 and first forearm motor 118 in a state in which the operator holds holding lever 172. Since the electromagnetic brakes can be released in the state in which the operator holds holding lever 172, first arm 112 can be prevented, by releasing the brakes, from being placed at an unintended position. Moreover, when holding lever 172 is attached to the same link mechanism as first holding device 113, first arm 112 can be moved while keeping holding lever 172 in the same posture. It should be noted that second transfer device 120 may also include holding lever 172 with brake releasing switch 171.

A first configuration is a picking device including: a rail that extends over a first area and a second area; a first transfer device that transports an object from the first area to the second area by picking up the object in the first area, traveling along the rail, and then releasing the object in the second area, the first transfer device including a first traveling body that travels while being guided by the rail, a first arm that includes a proximal end portion attached to the first traveling body, and a first holding device that is attached to a distal end portion of the first arm to hold an object; a second transfer device that transports an object from the first area to the second area by picking up the object in the first area, traveling along the rail, and then releasing the object in the second area, the second transfer device including a second traveling body that travels while being guided by the rail, a second arm that includes a proximal end portion attached to the second traveling body, and a second holding device that is attached to a distal end portion of the second arm to hold an object; and a transfer control device that controls the first transfer device and the second transfer device to cause the first transfer device and the second transfer device to pick up objects in parallel in the first area, travel in parallel along the rail, and then release the objects in parallel in the second area.

A second configuration includes the first configuration. In the second configuration, the first arm further includes: a first upper arm that includes a proximal end portion attached to the first traveling body to enable rotation of the first upper arm with respect to the first traveling body in a prescribed plane intersecting an extending direction of the rail and prevent motion of the first upper arm relative to the extending direction; and a first forearm that includes a proximal end portion attached to a distal end portion of the first upper arm to enable rotation of the first forearm with respect to the first upper arm in a plane parallel to the prescribed plane and prevent motion of the first forearm relative to the extending direction, the first holding device is attached to a distal end portion of the first forearm, the second arm further includes: a second upper arm that includes a proximal end portion attached to the second traveling body to enable rotation of the second upper arm with respect to the second traveling body in a plane parallel to the prescribed plane and prevent motion of the second upper arm relative to the extending direction; and a second forearm that includes a proximal end portion attached to a distal end portion of the second upper arm to enable rotation of the second forearm with respect to the second upper arm in a plane parallel to the prescribed plane and prevent motion of the second forearm relative to the extending direction, and the second holding device is attached to a distal end portion of the second forearm.

A third configuration includes the second configuration. In the third configuration, the first holding device is provided protruding toward the second transfer device with respect to the first forearm, and the second holding device is provided protruding toward the first transfer device with respect to the second forearm.

A fourth configuration includes any one of the first configuration, the second configuration, and the third configuration. In the fourth configuration, the picking device further includes a position deriver that derives a position of one or more objects placed in the first area. The transfer control device: controls driving of the first transfer device and the second transfer device to cause a position obtained by adding, on a second transfer device-side in the extending direction, a prescribed buffer distance to a first normal stop position at which the first holding device can stop when the first transfer device continues decelerating at a maximum deceleration not to be located on the second transfer device-side in the extending direction with respect to a second normal stop position at which the second holding device can stop when the second transfer device continues decelerating at a maximum deceleration; controls, based on positions of, among the one or more objects, two objects to be picked up by the first transfer device and the second transfer device obtained from the position deriver, the driving of the first transfer device and the second transfer device by using a first distance as the buffer distance, when a relative distance, in the extending direction, between the two objects is greater than or equal to a prescribed threshold; and controls the driving of the first transfer device and the second transfer device by using, as the buffer distance, a second distance that is shorter than the first distance, when the relative distance, in the extending direction, between the two objects is less than the prescribed threshold.

A fifth configuration includes any one of the first configuration, the second configuration, the third configuration, and the fourth configuration. In the fifth configuration, the picking device further includes: a position deriver that derives a position of one or more objects placed in the first area; and a picking determiner that determines, based on positions of, among the one or more objects, two objects to be picked up obtained from the position deriver, whether the first transfer device and the second transfer device can pick up the two objects in parallel. When a result of determination by the picking determiner is positive, the transfer control device controls the first transfer device and the second transfer device to cause the first transfer device and the second transfer device to pick up the two objects in parallel, and when the result of determination by the picking determiner is negative, the transfer control device controls the first transfer device and the second transfer device to cause the first transfer device to pick up one of the two objects in the first area and then cause the second transfer device to pick up another one of the two objects in the first area.

A sixth configuration includes the fifth configuration. In the sixth configuration, the position deriver determines positions of a plurality of objects in the first area in a vertical direction and in an extending direction of the rail, the picking determiner determines, by using an initial value of N set to 2, whether the first transfer device and the second transfer device can pick up, in parallel, a first height object and an N-th height object that are located at a highest height position and an N-th highest height position, respectively, among the positions in the vertical direction determined by the position deriver, when a result of determination by the picking determiner is positive, the transfer control device controls the first transfer device and the second transfer device to cause the first transfer device and the second transfer device to pick up the first height object and the N-th height object in parallel, and when the result of determination by the picking determiner is negative, the picking determiner repeats processing after adding 1 to N.

A seventh configuration includes the fifth configuration or the sixth configuration. In the seventh configuration, when the two objects in the first area overlap each other in a vertical direction, the picking determiner determines that the two objects cannot be picked up in parallel.

### INDUSTRIAL APPLICABILITY

This disclosure is applicable to a picking device that picks up, transfers, and releases an object.

What is claimed is:

1. A picking device comprising:
a rail that extends over a first area and a second area;
a first transfer device that transports an object from the first area to the second area by picking up the object in the first area, traveling along the rail, and then releasing the object in the second area, the first transfer device including a first traveling body that travels while being guided by the rail, a first arm that includes a proximal end portion attached to the first traveling body, and a first holding device that is attached to a distal end portion of the first arm to hold an object;
a second transfer device that transports an object from the first area to the second area by picking up the object in the first area, traveling along the rail, and then releasing the object in the second area, the second transfer device including a second traveling body that travels while being guided by the rail, a second arm that includes a proximal end portion attached to the second traveling body, and a second holding device that is attached to a distal end portion of the second arm to hold an object; and
a transfer control device that controls the first transfer device and the second transfer device to cause the first transfer device and the second transfer device to pick up objects in parallel in the first area, travel in parallel along the rail, and then release the objects in parallel in the second area.

2. The picking device according to claim 1, wherein the first arm further includes:
a first upper arm that includes a proximal end portion attached to the first traveling body to enable rotation of the first upper arm with respect to the first traveling body in a prescribed plane intersecting an extending direction of the rail and prevent motion of the first upper arm relative to the extending direction; and
a first forearm that includes a proximal end portion attached to a distal end portion of the first upper arm to enable rotation of the first forearm with respect to the first upper arm in a plane parallel to the prescribed plane and prevent motion of the first forearm relative to the extending direction,
the first holding device is attached to a distal end portion of the first forearm,
the second arm further includes:
a second upper arm that includes a proximal end portion attached to the second traveling body to enable rotation of the second upper arm with respect to the second traveling body in a plane parallel to the prescribed plane and prevent motion of the second upper arm relative to the extending direction; and
a second forearm that includes a proximal end portion attached to a distal end portion of the second upper arm to enable rotation of the second forearm with respect to the second upper arm in a plane parallel to the prescribed plane and prevent motion of the second forearm relative to the extending direction, and
the second holding device is attached to a distal end portion of the second forearm.

3. The picking device according to claim 2, wherein
the first holding device is provided protruding toward the second transfer device with respect to the first forearm, and
the second holding device is provided protruding toward the first transfer device with respect to the second forearm.

4. The picking device according to claim 3, further comprising:
a position deriver that derives a position of one or more objects placed in the first area, wherein
the transfer control device:
controls driving of the first transfer device and the second transfer device to cause a position obtained by adding, on a second transfer device-side in the extending direction, a prescribed buffer distance to a first normal stop position at which the first holding device can stop when the first transfer device continues decelerating at a maximum deceleration not to be located on the second transfer device-side in the extending direction with respect to a second normal stop position at which the second holding device can stop when the second transfer device continues decelerating at a maximum deceleration;
controls, based on positions of, among the one or more objects, two objects to be picked up by the first transfer device and the second transfer device obtained from the position deriver, the driving of the first transfer device and the second transfer device by using a first distance as the buffer distance, when a relative distance, in the extending direction, between the two objects is greater than or equal to a prescribed threshold; and
controls the driving of the first transfer device and the second transfer device by using, as the buffer distance, a second distance that is shorter than the first distance, when the relative distance, in the extending direction, between the two objects is less than the prescribed threshold.

5. The picking device according to claim 1, further comprising:
a position deriver that derives a position of one or more objects placed in the first area; and
a picking determiner that determines, based on positions of, among the one or more objects, two objects to be picked up obtained from the position deriver, whether the first transfer device and the second transfer device can pick up the two objects in parallel, wherein
when a result of determination by the picking determiner is positive, the transfer control device controls the first transfer device and the second transfer device to cause the first transfer device and the second transfer device to pick up the two objects in parallel, and
when the result of determination by the picking determiner is negative, the transfer control device controls the first transfer device and the second transfer device to cause the first transfer device to pick up one of the two objects in the first area and then cause the second transfer device to pick up another one of the two objects in the first area.

6. The picking device according to claim 5, wherein
the position deriver determines positions of a plurality of objects in the first area in a vertical direction and in an extending direction of the rail,
the picking determiner determines, by using an initial value of N set to 2, whether the first transfer device and the second transfer device can pick up, in parallel, a first height object and an N-th height object that are located at a highest height position and an N-th highest height position, respectively, among the positions in the vertical direction determined by the position deriver,
when a result of determination by the picking determiner is positive, the transfer control device controls the first transfer device and the second transfer device to cause the first transfer device and the second transfer device to pick up the first height object and the N-th height object in parallel, and
when the result of determination by the picking determiner is negative, the picking determiner repeats processing after adding 1 to N.

7. The picking device according to claim 5, wherein
when the two objects in the first area overlap each other in a vertical direction, the picking determiner determines that the two objects cannot be picked up in parallel.

8. The picking device according to claim 6, wherein
when the two objects in the first area overlap each other in a vertical direction, the picking determiner determines that the two objects cannot be picked up in parallel.
